(19) United States
(12) Patent Application Publication
(10) Pub. No.: US 2006/0013081 A1
(43) Pub. Date: Jan. 19, 2006

(54) Orienting a learner with recorded audio

(76) Inventors: Joel Lane Williams JR., Troy, TX (US); Jessica Maria Williams, Troy, TX (US)

Correspondence Address: ROGERS LAW OFFICE, 701 BRAZOS STREET, SUITE 500, AUSTIN, TX, 78701, US

(21) Appl. No.: 11/180,243

(22) Filed: Jul. 13, 2005

Related U.S. Application Data
(60) Provisional application No. 60/587,722, filed on Jul. 13, 2004.

(51) Int. Cl. G11B 21/08

(52) U.S. Cl. 369/30.19

(57) ABSTRACT

Disclosed are methods of orienting a learner using recorded audio. Carrying out the methods may comprise recording two or more unique audio messages on an analogous number of recordable devices; positioning the recordable devices at an analogous number of unique locations; and retrieving one or more of the messages to orient a learner with respect to the locations. Carrying out the methods may further comprise recording an audio message indicating left on a first recordable device; recording an audio message indicating right on a second recordable device; attaching the first recordable device to a left article; attaching the second recordable device to a right article; and retrieving the message indicating left to identify the left article and the message indicating right to identify the right article.

### CROSS-REFERENCE TO RELATED APPLICATION

This application claims the benefit of and priority to provisional U.S. Patent Application No. 60/587,722, filed 13 Jul. 2004 and entitled “Button Recording Device.”

### FIELD OF THE INVENTION

This application generally relates to orienting a learner with recorded audio and, more particularly, to orienting a learner with two or more unique audio messages recorded on two or more recordable devices positioned in two or more locations.

### PROBLEM STATEMENT

A consideration is that audio recordings have been used to convey messages. Examples of using audio recordings to convey messages include telephone answering systems, warning systems, audiocassette study courses, and the like.

Another consideration is that various tools and methods that facilitate learning and retention have been developed. Examples of tools that facilitate learning and retention include jingles, visual aids, and toys incorporating playable audio recordings. The desire to facilitate learning and retention continues. Thus, the need for tools and methods that facilitate learning and retention persists.

### SUMMARY OF THE INVENTION

In various embodiments methods of orienting a learner using recorded audio are disclosed. Carrying out the methods may comprise recording two or more unique audio messages on an analogous number of recordable devices; positioning the recordable devices at an analogous number of unique locations; and retrieving one or more of the messages to orient a learner with respect to the locations. In embodiments, a learner is a human, a robot, a primate, a pet, a human with a disability, or a child. Unique audio messages may assist a learner in distinguishing among unique locations. Such unique locations may comprise reference points, compass directions, up and down, right and left, inside and outside, or combinations thereof.

Carrying out the methods may further comprise recording an audio message indicating left on a first recordable device; recording an audio message indicating right on a second recordable device; attaching the first recordable device to a left article; attaching the second recordable device to a right article; and retrieving the message indicating left to identify the left article and the message indicating right to identify the right article. In embodiments, the left article and right article comprise shoes, gloves, socks, or combinations thereof. The methods can orient a learner with respect to appropriate use of the left article and right article.

### BRIEF DESCRIPTION OF THE DRAWINGS

FIG. 1 illustrates an embodiment wherein recordable devices are attached to a pair of shoes.

FIG. 2 illustrates a perspective view of an embodiment of a recordable device.

### DETAILED DESCRIPTION OF EMBODIMENTS

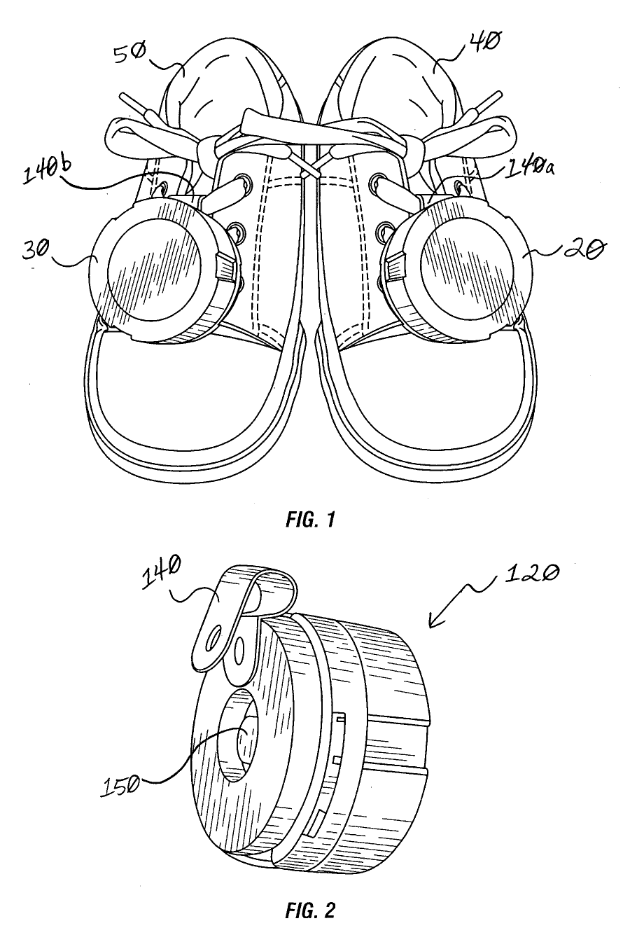

In an embodiment of the methods disclosed herein illustrated by FIG. 1, an audio message indicating left is recorded on a first recordable device 20, and an audio message indicating right is recorded on a second recordable device 30. The first recordable device 20 is attached to a left shoe 40, and the second recordable device 30 is attached to a right shoe 50. An audio message is retrieved by pressing a button (not shown in FIG. 1) on the first recordable device 20 or the second recordable device 30. Pressing the button on the first recordable device 20 attached to the left shoe 40 retrieves the audio message indicating left and plays the message for a learner, such as a child (not shown). For example, the audio message indicating left may be: “This is your left shoe”. Likewise, pressing the button on the second recordable device 30 attached to the right shoe 50 retrieves the audio message indicating right and plays the message for the learner. For example, the audio message indicating right may be: “This is your right shoe”.

The embodiment illustrated by FIG. 1 may be employed to orient a learner with respect to appropriate use of the left shoe 40 and right shoe 50. The methods disclosed herein assume that a learner is capable of comprehending audio messages, such as audible signals or words. Playing a message by pressing a button may be demonstrated to and repeated by a learner that does not otherwise recognize which shoe goes on which foot. With one or more repetitions of the method of identifying the left shoe and right shoe via the audio messages, the method may assist such an unknowing learner in recognizing and retaining the differences between a left shoe and right shoe.

It is recognized that the presently disclosed methods are desirably employed as teaching tools. Accordingly, it is anticipated that some learners may employ the methods disclosed herein indefinitely, thus employing the methods each time orientation is needed. It is also anticipated that some learners may employ the method a few times, or even one time, before becoming oriented and retaining orientation with respect to unique locations. Thus, the need for the present methods may be reduced as a learner experiences retention/recognition and is capable of becoming oriented without such methods. For example, in the case illustrated by FIG. 1, it is assumed that a learner may be capable of retaining orientation with respect to placement of the left shoe on the left foot and the right shoe on the right foot once the learner recognizes additional unique features, other than differentiating audio messages, associated with the left shoe and right shoe. Such recognition of additional unique features, such as differences between the shape of a left shoe and the shape of a right shoe, after repeated use of the methods disclosed herein, may both highlight the usefulness of and eliminate the need for the disclosed methods.

Non-limiting examples of learners for purposes of the present disclosure are humans, robots, primates, pets, humans with disabilities, and children. A learner may be anything capable of being trained via comprehension of audio messages. In some embodiments, a learner is a group of learners, such as a group of humans with learning disabilities. In the embodiment of FIG. 1, the method may be appropriate for children and any person that has difficulties putting shoes on the correct foot.

The recordable device disclosed herein may be any device or combination of devices capable of storing an audio message and playing the stored audio message. An example of a recordable device is a re-recordable device capable of storing a first message, then recording a second message over the first message, a third message over the second message, and so forth. A re-recordable device may be capable of storing any number of messages that replace the previous message. In another example, the recordable device may be capable of recording a first message, adding a second message after the first message that is in addition to the first message, adding a third message after the second message that is in addition to the first and second messages, and so forth. Any number of variations of suitable recordable devices may be found commercially. One such recordable device is the RECORD-IT recordable device available from Darice Incorporated of Strongsville, Ohio.

FIG. 1 and FIG. 2 illustrate a suitable recordable device. FIG. 1 shows two recordable devices, a first recordable device 20 attached to a left shoe 40 and a second recordable device 30 attached to a right shoe 50. FIG. 2 shows a different perspective of a similar recordable device 120. In the view of FIG. 2 some additional features of the recordable device 120 are illustrated. The recordable device 120 of FIG. 2 includes a clip 140 that facilitates attachment of the device 120 at a location. FIG. 1 provides an example of a clip 140 attaching a device at a location. The edge of a clip 140 is visible in FIG. 1 where one clip 140a affixes the first recordable device 20 to the left shoe 40, and another clip 140b affixes the second recordable device 30 to the right shoe 50. Although the recordable device 120 of FIG. 2 includes a clip 140, any suitable means of attaching a recordable device 120 to a location, such as a shoe, may be employed. Another example of a suitable means for attaching a recordable device, particularly with shoes, is use of eyelet loops through which shoestrings may be laced for attaching to shoes. The recording device may be attached to any style of shoe. Furthermore, the device may be built into the tongue or other areas of a shoe. In some embodiments, a recordable device may display decorative features, such as artwork, colors, stickers, figures, a decorative shape/design, and the like. Such decorative features may influence a learner's desire to engage the methods disclosed.

The recordable device 120 of FIG. 2 also includes a means of actuating message playback. In the embodiment of FIG. 2, a button 150 permits actuation of message playback. Thus, when message playback is desired, a user/learner may actuate message playback by pushing the button 150. In addition to a button 150, any suitable means of actuating message playback may be employed. In addition, actuation may occur manually, such as by pushing a button, or remotely via wireless or other electronic means.

The recording device may store the audio message or messages on one or more electronic recording chips. Additionally, operation of the device may be battery powered. The recordable device typically includes one or more speakers that allow playback of one or more audio messages to a learner or learners.

The audio messages disclosed herein may comprise single words, groups of words, adages, phrases, single sentences, groups of sentences, sounds, or combinations thereof. Words may be recorded in any language. Further, sounds may be signals rather than words, and the sounds/signals may be in the form of a code, whether the code is commonly known, such as the Morse code, or created for use with a particular learner or learners. Non-limiting examples of effective words that may be employed, either alone or in combination with other words, in order to orient a learner with respect to one or more locations include: right, left, north, south, up, down, and the like.

Unique locations may be any reference points, positions, or directions effective for orienting a learner. In the embodiment illustrated by FIG. 1, the unique locations were right and left, and particularly right foot, left foot, right shoe, and left shoe. The methods disclosed in the present application orient a learner with respect to such locations by uniquely identifying such locations to the learner. Non-limiting examples of unique locations include compass directions, up and down, right and left, inside and outside, or combinations thereof. Non-limiting examples of situations where a learner may be oriented using unique locations include while putting on articles of clothing, such as shoes or gloves, putting on sports equipment, such as a baseball mitt, while arranging furniture, while assembling equipment or furniture, while directing a guide dog, and so on.

While preferred embodiments of the invention have been shown and described, modifications thereof can be made by one skilled in the art without departing from the spirit and teachings of the invention. The embodiments described herein are exemplary only, and are not intended to be limiting. Many variations and modifications of the invention disclosed herein are possible and are within the scope of the invention. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an embodiment of the present invention. Thus, the claims are a further description and are an addition to the preferred embodiments of the present invention.

What is claimed:

1. A method of orienting a learner with recorded audio comprising:
recording two or more unique audio messages on an analogous number of recordable devices;
positioning the recordable devices at an analogous number of unique locations; and
retrieving one or more of the messages to orient a learner with respect to the locations.

2. The method of claim 1 wherein a learner comprises a human, a robot, a primate, a pet, a human with a disability, or a child.

3. The method of claim 1 wherein a learner comprises a human child.

4. The method of claim 1 wherein the recordable devices comprise re-recordable devices.

5. The method of claim 1 wherein the unique audio messages comprise single words, groups of words, adages, phrases, single sentences, groups of sentences, sounds, or combinations thereof.

6. The method of claim 1 wherein the unique audio messages assist a learner in distinguishing among unique locations.

7. The method of claim 1 wherein the unique locations comprise reference points, compass directions, up and down, right and left, inside and outside, or combinations thereof.

8. The method of claim 1 wherein retrieving one or more of the messages further comprises actuating message playback.

9. A method comprising:
recording an audio message indicating left on a first recordable device;
recording an audio message indicating right on a second recordable device;
attaching the first recordable device to a left article;
attaching the second recordable device to a right article; and
retrieving the message indicating left to identify the left article and the message indicating right to identify the right article.

10. The method of claim 9 wherein the audio message comprises one or more words.

11. The method of claim 9 wherein the first recordable device and second recordable device consist of a re-recordable device.

12. The method of claim 9 wherein the left article and right article comprise articles of clothing.

13. The method of claim 9 wherein the left article and right article comprise shoes, gloves, socks, or combinations thereof.

14. The method of claim 9 wherein retrieving the message further comprises actuating the recordable device.

15. The method of claim 14 wherein actuating the recordable device comprises pressing a button located on the recordable device.

16. The method of claim 9 wherein the method orients a learner with respect to appropriate use of the left article and right article.

17. The method of claim 9 further comprising teaching a child to associate the left article with a left appendage and the right article with a right appendage.

18. The method of claim 16 wherein the learner is a child, the left article is a left shoe, and the right article is a right shoe.
